(19) United States
(12) Patent Application Publication
(10) Pub. No.: US 2026/0133289 A1
(43) Pub. Date: May 14, 2026

(54) COAXIAL LASER RANGING AND SIGHTING SYSTEM

(71) Applicant: Shenzhen Valueplus2 Electronics Co., Ltd., Shenzhen (CN)

(72) Inventor: Conglin SUN, Shenzhen (CN)

(73) Assignee: Shenzhen Valueplus2 Electronics Co., Ltd., Shenzhen (CN)

(21) Appl. No.: 19/024,877

(22) Filed: Jan. 16, 2025

(30) Foreign Application Priority Data
Nov. 14, 2024 (CN) 202411631202.6

(51) Int. Cl. G01S 7/481; G02B 5/04

(52) U.S. Cl. CPC G01S 7/4812; G02B 5/04

(57) ABSTRACT

Provided is a coaxial laser ranging and sighting system, which includes a laser emitter, a collimating lens, a first glued prism, a second glued prism, a focusing lens, a photoelectric detector, an eyepiece and an objective lens. The collimating lens is arranged on a transmission optical path of an incident beam and is configured to collimate the incident beam into incident parallel light; the first glued prism is arranged on a transmission optical path of the incident parallel light and is configured to reflect the incident parallel light and emit the incident parallel light along an optical axis; the second glued prism is arranged on the optical axis and is configured to change a transmission optical path of a recovered beam; the eyepiece, the second glued prism, the first glued prism and the objective lens are arranged in sequence along a direction in which the optical axis extends.

### CROSS-REFERENCE TO RELATED PRESENT DISCLOSURE

This patent application claims the benefit and priority of Chinese Patent Application No. 202411631202.6 filed with the China National Intellectual Property Administration on Nov. 14, 2024, the disclosure of which is incorporated by reference herein in its entirety as part of the application.

### TECHNICAL FIELD

The present disclosure relates to the technical field of sighting systems, and in particular to a coaxial laser ranging and sighting system.

### BACKGROUND

A laser ranging and gun-sighting device integrates two functions: a laser rangefinder and a gun sight. Before shooting, users can obtain the target distance through the laser rangefinder quickly and accurately. At the same time, the gun sight helps the users focus sight at the target accurately. The workflow simplifies the preparation before shooting greatly and improves the shooting efficiency.

An existing gun sight with a ranging function usually allows a transmitting system to be independent of and parallel to the optical axis of the sighting system, and a receiving system is embedded into the sighting system through prism reflection. The advantage is that the structure is simple, but the disadvantage is that the ranging position and the sighting position are different in the using process since transmission and sighting reception are performed on different axes.

### SUMMARY

The present disclosure aims to provide a coaxial laser ranging and sighting system, so as to solve the problems existing in the prior art and reduce errors of gun sighting and ranging.

In order to achieve the above objectives, the present disclosure provides the following scheme.

The present disclosure provides a coaxial laser ranging and sighting system, including:
a laser emitter configured to provide an incident beam;
a collimating lens arranged on a transmission optical path of the incident beam and configured to collimate the incident beam into incident parallel light;
a first glued prism arranged on a transmission optical path of the incident parallel light and configured to reflect the incident parallel light and emit the incident parallel light along an optical axis;
a second glued prism arranged on the optical axis and configured to change a transmission optical path of a recovered beam;
a focusing lens arranged on a changed transmission optical path of the recovered beam in a transmission direction changed by the second glued prism and configured to focus the recovered beam on a photosensitive surface of a photoelectric detector;
the photoelectric detector configured to receive the recovered beam;
an eyepiece arranged on the optical axis;
an objective lens arranged on the optical axis; wherein the eyepiece, the second glued prism, the first glued prism and the objective lens are arranged in sequence along a direction in which the optical axis extends.

In some embodiments, the first glued prism includes a first prism and a second prism which are prismatic, a cross section of the first prism is an isosceles trapezoid, a cross section of the second prism is a right trapezoid, and a large end face of the first prism faces towards the objective lens; the large end face of the first prism is perpendicular to and intersects with the optical axis, and a small end face of the first prism is perpendicular to but does not intersect with the optical axis; an inclined side of the first prism intersecting with the optical axis is a first inclined surface, and the other side of the first prism is a second inclined surface; an inclined side of the second prism is glued with the first inclined surface to form a prismatic structure with a right trapezoid cross section; and the second glued prism is arranged between the first glued prism and the eyepiece.

In some embodiments, the laser emitter is parallel to the optical axis and arranged on one side of a large end of the first prism, and a laser emitting end of the laser emitter faces towards the second inclined surface.

In some embodiments, an included angle between the second inclined surface and the optical axis is 45 degrees.

In some embodiments, the second glued prism includes a third prism and a fourth prism; the third prism is configured to have a third incident surface, a third reflection surface and a third transmission surface, the third incident surface is located on one side of the first glued prism facing towards the eyepiece, and the third incident surface is perpendicular to and intersects with the optical axis; the third reflection surface and the third transmission surface are both located on one side of the third incident surface facing towards the eyepiece. The fourth prism includes a fourth exit surface, a fourth transmission surface and a fourth reflection surface, the fourth transmission surface is glued with the third transmission surface, the third reflection surface is configured to reflect the recovered beam to the fourth transmission surface and the third transmission surface, the fourth transmission surface and the third transmission surface are configured to transmit the recovered beam to the fourth reflection surface, the fourth reflection surface is configured to reflect the recovered beam into a detection beam along a direction parallel to the optical axis; and the fourth exit surface is arranged on a transmission path of the detection beam and is perpendicular to the optical axis.

In some embodiments, a filter film is arranged between the third transmission surface and the fourth transmission surface.

In some embodiments, the coaxial laser ranging and sighting system further includes a focusing lens fixed sleeve and a photoelectric detector focal length adjusting sleeve, wherein the focusing lens is detachably arranged in the focusing lens fixed sleeve, the photoelectric detector focal length adjusting sleeve is in a threaded connection with the focusing lens fixed sleeve, the photoelectric detector is fixed in the photoelectric detector focal length adjusting sleeve, and a distance between the focusing lens and the photoelectric detector is adjusted by adjusting a depth of the threaded connection.

In some embodiments, the coaxial laser ranging and sighting system further includes a collimating lens sleeve and a laser emitter fixed sleeve, the laser emitter is fixedly arranged in the laser emitter fixed sleeve, the collimating lens is fixedly arranged in the collimating lens sleeve, a cylindrical space is formed in the laser emitter fixed sleeve, the collimating lens sleeve is slidable and is arranged rotatably around its own axis in the cylindrical space, an adjusting channel extending along a first trajectory is formed in a peripheral side wall surface of the cylindrical space, and the first trajectory has axial and radial components; an adjusting column is fixedly arranged on a side wall of the collimating lens sleeve and extends into the adjusting channel, and a position of the collimating lens relative to the laser emitter is adjusted by adjusting a position of the adjusting column in the adjusting channel.

In some embodiments, the laser emitter is a semiconductor laser, and the laser emitter is capable of emitting infrared light with a wavelength of 905 nm.

Compared with the prior art, the present disclosure has the following technical effects.

In the coaxial laser ranging and sighting system provided by the present disclosure, the recovered beam and the emitted beam, as well as the eyepiece and the objective lens are in the same optical axis, so that the problem in the prior art that sighting and ranging do not refer to the same point is solved, and use errors of gun sighting and ranging are reduced.

### BRIEF DESCRIPTION OF THE DRAWINGS

In order to explain the technical schemes in the embodiments of the present disclosure or the prior art more clearly, the drawings needed in the embodiments will be briefly introduced hereinafter. Obviously, the drawings described below are only some embodiments of the present disclosure. Other drawings can be obtained according to these drawings without paying creative labor for those skilled in the art.

FIG. 1 is an optical path diagram of a coaxial laser ranging and sighting system according to an embodiment of the present disclosure.

FIG. 2 is a schematic structural diagram of a coaxial laser ranging and sighting system according to an embodiment of the present disclosure.

FIG. 3 is a schematic diagram of a remaining structure of FIG. 2 after removing an eyepiece and an objective lens.

FIG. 4 is a schematic structural diagram of a first glued prism and a second glued prism.

FIG. 5 is an exploded diagram of a structure of FIG. 4.

In the figures: 1—laser emitter; 2—collimating lens; 3—first glued prism; 4—objective lens; 5—second glued prism; 6—focusing lens; 7—photoelectric detector; 8—shell; 9—eyepiece; 11—incident beam; 12—incident parallel light; 13—optical axis; 14—recovered beam; 21—photoelectric detector focal length adjusting sleeve; 22—focusing lens fixed sleeve; 23—laser emitter fixed sleeve; 24—collimating lens sleeve; 31—first prism; 32—second prism; 33—third prism; 34—fourth prism; 35—prism group; 36—eyepiece group; 311—large end face; 312—first inclined surface; 313—second inclined surface; 314—small end face; 331—third incident surface; 332—third reflection surface; 333—third transmission surface; 341—fourth transmission surface; 342—fourth exit surface; 343—fourth reflection surface

### DETAILED DESCRIPTION OF THE EMBODIMENTS

The technical scheme in the embodiments of the present disclosure will be clearly and completely described with reference to the drawings in the embodiments of the present disclosure hereinafter. Obviously, the described embodiments are only some embodiments of the present disclosure, rather than all of the embodiments. Based on the embodiments in the present disclosure, all other embodiments obtained by those skilled in the art without paying creative labor belong to the scope of protection of the present disclosure.

In order to make the above objectives, features and advantages of the present disclosure more obvious and understandable, the present disclosure will be further described in detail with reference to the drawings and the detailed description hereinafter.

In order to facilitate understanding, the following description is provided.

In the related art, a laser ranging system can be classified into a receiving-transmitting non-coaxial optical path and a receiving-transmitting coaxial optical path according to the optical path. The difference between the coaxial optical path and the non-coaxial optical path lies in whether the transmitting optical axis and the receiving optical axis are coaxial or not. At present, laser ranging gun sights are all non-coaxial optical path systems. In a ranging and sighting non-coaxial optical path system, the transmitting system is separated from the sighting system. The transmitting system includes a laser transmitting module, a window lens, a transmitting channel, etc. The receiving system includes an optical focusing lens, an optical filter, a receiving channel, an avalanche tube, etc.. The laser module is a module consisting of a semiconductor laser diode, an optical collimating lens and a copper sleeve, which is responsible for emitting a collimated and shaped laser beam. In the ranging and sighting non-coaxial optical path system, a laser module emits a collimated and shaped laser beam, which is usually infrared light of 905 nm or 940 nm. The collimated and shaped laser beam passes through air or other media and then hits the target, and the laser beam diffusely reflected by the target may be collected by the optical lens of the receiving system and focused on the photosensitive surface of the photoelectric detector. As the emitted beam and stray light of other wave bands are received, other unwanted stray light needs to be filtered out by an optical filter, and only the light of the required wave band is reserved. Photoelectric detector, after the avalanche tube senses photons, generates an avalanche phenomenon, converts optical signals into electrical signals, and transmits the signals to a computing terminal.

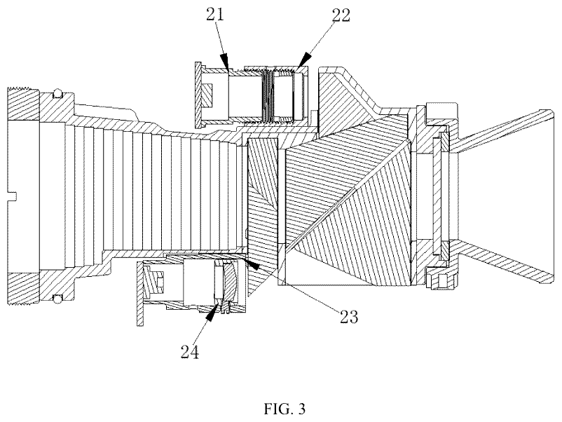

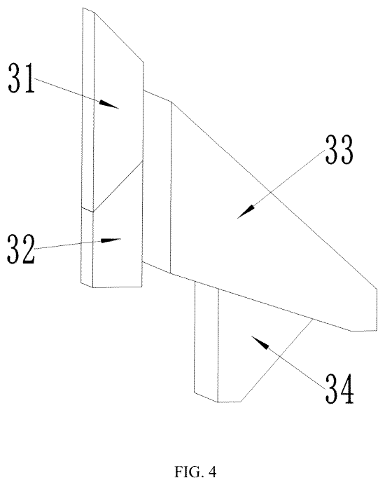

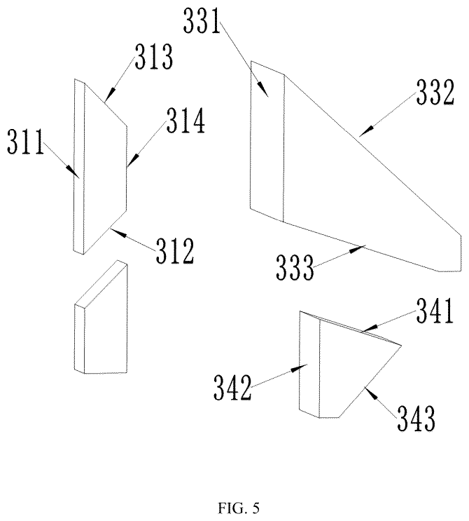

The embodiments of the present disclosure will be described with reference to FIGS. 1 to 5 hereinafter.

The present disclosure provides a coaxial laser ranging and sighting system, which includes a laser emitter 1, a collimating lens 2, a first glued prism 3, a second glued prism 5, a focusing lens 6, a photoelectric detector 7, an eyepiece 9 and an objective lens 4.

The laser emitter 1 is configured to provide an incident beam 11. The collimating lens 2 is arranged on a transmission optical path of the incident beam 11, and is configured to collimate the incident beam 11 into incident parallel light 12. The first glued prism 3 is arranged on a transmission path of the incident parallel light 12, and is configured to reflect the incident parallel light 12 and emit the incident parallel light along an optical axis 13. The second glued prism 5 is arranged on the optical axis 13, and is configured to change a transmission optical path of a recovered beam 14. The focusing lens 6 is arranged on a changed transmission optical path of the recovered beam 14 in a transmission direction changed by the second glued prism 5, and is configured to focus the recovered beam 14 on a photosensitive surface of the photoelectric detector 7. The photoelectric detector 7 is configured to receive the recovered beam 14. The eyepiece 9 is arranged on the optical axis 13. The objective lens 4 is arranged on the optical axis 13. The eyepiece 9, the second glued prism 5, the first glued prism 3 and the objective lens 4 are arranged in sequence along a direction in which the optical axis 13 extends.

Specifically, the first glued prism 3 includes a first prism 31 and a second prism 32 which are prismatic. A cross section of the first prism 31 is an isosceles trapezoid. A cross section of the second prism 32 is a right trapezoid. A large end face 311 of the first prism 31 faces towards the objective lens 4. The large end face 311 of the first prism 31 is perpendicular to and intersects with the optical axis 13, and a small end face 314 of the first prism 31 is perpendicular to but does not intersect with the optical axis 13. An inclined side of the first prism 31 intersecting with the optical axis 13 is a first inclined surface 312, and the other side of the first prism 31 is a second inclined surface 313. An inclined side of the second prism 32 is glued with the first inclined surface 312 to form a prismatic structure with a right trapezoid cross section. The second glued prism 5 is arranged between the first glued prism 3 and the eyepiece 9.

The second glued prism 5 includes a third prism 33 and a fourth prism 34. The third prism 33 is configured to have a third incident surface 331, a third reflection surface 332 and a third transmission surface 333. The third incident surface 331 is located on one side of the first glued prism 3 facing towards the eyepiece 9. The third incident surface 331 is perpendicular to and intersects with the optical axis 13. The third reflection surface 332 and the third transmission surface 333 are both located on one side of the third incident surface 331 facing towards the eyepiece 9. The fourth prism 34 includes a fourth exit surface 342, a fourth transmission surface 341 and a fourth reflection surface 343. The fourth transmission surface 341 is glued with the third transmission surface 333. The third reflection surface 332 is configured to reflect the recovered beam 14 to the fourth transmission surface 341 and the third transmission surface 333. The fourth transmission surface 341 and the third transmission surface 333 are configured to transmit the recovered beam 14 to the fourth reflection surface 343. The fourth reflection surface 343 is configured to reflect the recovered beam 14 into a detection beam along a direction parallel to the optical axis 13. The fourth exit surface 342 is arranged on a transmission path of the detection beam and is perpendicular to the optical axis 13.

In the coaxial laser ranging and sighting system provided by the present disclosure, the recovered beam 14 and the emitted beam, as well as the eyepiece 9 and the objective lens 4 are in the same optical axis 13, so that the problem in the prior art that sighting and ranging do not refer to the same point is solved, and use errors of gun sighting and ranging are reduced.

In some embodiments, the laser emitter 1 is parallel to the optical axis 13 and arranged on one side of a large end of the first prism 31, and a laser emitting end of the laser emitter 1 faces towards the second inclined surface 313.

In some embodiments, an included angle between the second inclined surface 313 and the optical axis 13 is 45 degrees.

In some embodiments, a filter film is arranged between the third transmission surface 333 and the fourth transmission surface 341.

The filter film in the embodiment is configured to filter visible light, and infrared light can be incident on the fourth transmission surface 341 through the filter film.

In some embodiments, the embodiments of the present disclosure further include a focusing lens fixed sleeve 22 and a photoelectric detector focal length adjusting sleeve 21. The focusing lens 6 is detachably arranged in the focusing lens fixed sleeve 22. The photoelectric detector focal length adjusting sleeve 21 is in a threaded connection with the focusing lens fixed sleeve 22. The photoelectric detector 7 is fixed in the photoelectric detector focal length adjusting sleeve 21. A distance between the focusing lens 6 and the photoelectric detector 7 is adjusted by adjusting a depth of the threaded connection.

The embodiment adjusts the distance between the focusing lens 6 and the photoelectric detector 7 more conveniently.

In some embodiments, the embodiments of the present disclosure further include a collimating lens sleeve 24 and a laser emitter fixed sleeve 23. The laser emitter 1 is fixedly arranged in the laser emitter fixed sleeve 23. The collimating lens 2 is fixedly arranged in the collimating lens sleeve 24. A cylindrical space is formed in the laser emitter fixed sleeve 23. The collimating lens sleeve 24 is slidable and is arranged rotatably around its own axis in the cylindrical space. An adjusting channel extending along a first trajectory is formed in a peripheral side wall surface of the cylindrical space. The first trajectory has axial and radial components. An adjusting column is fixedly arranged on a side wall of the collimating lens sleeve 24 and extends into the adjusting channel. A position of the collimating lens 2 relative to the laser emitter 1 is adjusted by adjusting a position of the adjusting column in the adjusting channel.

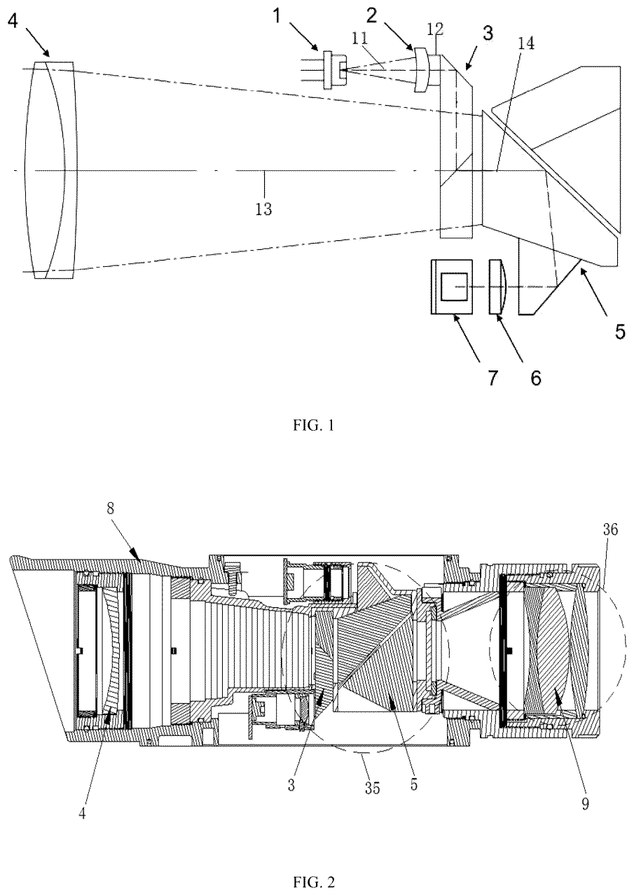

The embodiment adjusts the distance between the collimating lens 2 and the laser emitter 1 more conveniently. In addition, as shown in FIG. 2, the collimating lens sleeve 24, the laser emitter fixed sleeve 23, the focusing lens fixed sleeve 22 and the photoelectric detector focal length adjusting sleeve 21 are all parallel to the optical axis 13, which can reduce the size of the sighting system in the radial direction.

In some embodiments, the laser emitter 1 is a semiconductor laser, and the laser emitter 1 is capable of emitting infrared light with a wavelength of 905 nm. A fast axis divergence angle is 24 degrees, and a slow axis divergence angle is 6 degrees.

In some embodiments, both sides of the prism group 35 along the direction of the optical axis are perpendicular to and intersects with the optical axis 13.

It is noted that in the embodiments of the present disclosure, the laser emitter 1, the collimating lens 2, the first glued prism 3 and the objective lens 4 form a transmitting system together, which is configured to emit a collimated and shaped laser beam, which is infrared light with a wavelength of 905 nm. The photoelectric detector 7, the focusing lens 6, the second glued prism 5 and the objective lens 4 form a receiving system together, which is configured to receive the ray of light diffusely reflected by the target and focus the ray of light on the photoelectric detector 7.

The working principle is as follows.

The laser beam emitted by the laser emitter 1 is collimated preliminarily through the collimating lens 2, thereafter, enters the first glued prism 3, after two reflections, enters the objective lens 4, and is finally collimated and then emitted by the objective lens. The emitted laser light enters the objective lens 4 after being reflected by the surface to be measured, passes through the first glued prism 3, and then enters the second glued prism 5. The second glued prism has the function of separating the visible light band from the infrared light band. The separated infrared light is reflected, then enters the focusing lens 6, and finally focuses on the photoelectric detector 7.

In the present disclosure, specific examples are used to illustrate the principle and implementation of the present disclosure. The description of the above embodiments is only used to help understand the method and the core idea of the present disclosure. At the same time, there will be changes in the detailed description and the application range according to the idea of the present disclosure for those skilled in the art. To sum up, the contents of the specification should not be construed as limiting the present disclosure.

1. A coaxial laser ranging and sighting system, comprising:
a laser emitter configured to provide an incident beam;
a collimating lens arranged on a transmission optical path of the incident beam and configured to collimate the incident beam into incident parallel light;
a first glued prism arranged on a transmission optical path of the incident parallel light and configured to reflect the incident parallel light to form an emitted beam emitted along an optical axis;
a second glued prism arranged on the optical axis and configured to change a transmission optical path of a recovered beam;
a focusing lens arranged on a changed transmission optical path of the recovered beam in a transmission direction changed by the second glued prism and configured to focus the recovered beam on a photosensitive surface of a photoelectric detector;
the photoelectric detector configured to receive the recovered beam;
an eyepiece arranged on the optical axis; and
an objective lens arranged on the optical axis; wherein the eyepiece, the second glued prism, the first glued prism and the objective lens are arranged in sequence along a direction in which the optical axis extends.

2. The coaxial laser ranging and sighting system according to claim 1, wherein the first glued prism comprises a first prism and a second prism which are prismatic, a cross section of the first prism is an isosceles trapezoid, a cross section of the second prism is a right trapezoid, and a large end face of the first prism faces towards the objective lens; the large end face of the first prism is perpendicular to and intersects with the optical axis, and a small end face of the first prism is perpendicular to but does not intersect with the optical axis; an inclined side of the first prism intersecting with the optical axis is a first inclined surface, and an other side of the first prism is a second inclined surface; an inclined side of the second prism is glued with the first inclined surface to form a prismatic structure with a cross section of a right trapezoid shape; and the second glued prism is arranged between the first glued prism and the eyepiece.

3. The coaxial laser ranging and sighting system according to claim 2, wherein the laser emitter is parallel to the optical axis and arranged on one side of a large end of the first prism, and a laser emitting end of the laser emitter faces towards the second inclined surface.

4. The coaxial laser ranging and sighting system according to claim 3, wherein an included angle between the second inclined surface and the optical axis is 45 degrees.

5. The coaxial laser ranging and sighting system according to claim 3, wherein the second glued prism comprises a third prism and a fourth prism; the third prism is configured to have a third incident surface, a third reflection surface and a third transmission surface, the third incident surface is located on one side of the first glued prism facing towards the eyepiece, and the third incident surface is perpendicular to and intersects with the optical axis; the third reflection surface and the third transmission surface are both located on one side of the third incident surface facing towards the eyepiece; the fourth prism comprises a fourth exit surface, a fourth transmission surface and a fourth reflection surface, the fourth transmission surface is glued with the third transmission surface, the third reflection surface is configured to reflect the recovered beam to the fourth transmission surface and the third transmission surface, the fourth transmission surface and the third transmission surface are configured to transmit the recovered beam to the fourth reflection surface, the fourth reflection surface is configured to reflect the recovered beam into a detection beam along a direction parallel to the optical axis; and the fourth exit surface is arranged on a transmission path of the detection beam and is perpendicular to the optical axis.

6. The coaxial laser ranging and sighting system according to claim 5, wherein a filter film is arranged between the third transmission surface and the fourth transmission surface.

7. The coaxial laser ranging and sighting system according to claim 1, further comprising a focusing lens fixed sleeve and a photoelectric detector focal length adjusting sleeve, wherein the focusing lens is detachably arranged in the focusing lens fixed sleeve, the photoelectric detector focal length adjusting sleeve is in a threaded connection with the focusing lens fixed sleeve, the photoelectric detector is fixed in the photoelectric detector focal length adjusting sleeve, and a distance between the focusing lens and the photoelectric detector is adjusted by adjusting a depth of the threaded connection.

8. The coaxial laser ranging and sighting system according to claim 1, further comprising a collimating lens sleeve and a laser emitter fixed sleeve, wherein the laser emitter is fixedly arranged in the laser emitter fixed sleeve, the collimating lens is fixedly arranged in the collimating lens sleeve, a cylindrical space is formed in the laser emitter fixed sleeve, the collimating lens sleeve is slidable and is arranged rotatably around its own axis in the cylindrical space, an adjusting channel extending along a first trajectory is formed in a peripheral side wall surface of the cylindrical space, and the first trajectory has axial and radial components; an adjusting column is fixedly arranged on a side wall of the collimating lens sleeve and extends into the adjusting channel, and a position of the collimating lens relative to the laser emitter is adjusted by adjusting a position of the adjusting column in the adjusting channel.

9. The coaxial laser ranging and sighting system according to claim 1, wherein the laser emitter is a semiconductor laser and is capable of emitting infrared light with a wavelength of 905 nm.
